(19) United States
(12) Patent Application Publication
(10) Pub. No.: US 2023/0360189 A1
(43) Pub. Date: Nov. 9, 2023

(54) METHOD AND SYSTEM OF ANALYZING PLANT IMAGE DATA AND PROJECTING PLANT GROWTH AND HEALTH STATUS

(71) Applicant: BIFARM TECH, INC., Sunnrise, FL (US)

(72) Inventor: WANJUN GAO, Weston, FL (US)

(21) Appl. No.: 18/021,854

(22) PCT Filed: Aug. 23, 2021
(86) PCT No.: PCT/US21/47190

§ 371 Date: Feb. 17, 2023

Related U.S. Application Data
(60) Provisional application No. 63/069,030, filed on Aug. 22, 2020.

(51) Int. Cl. G06T 7/00; G06T 11/00

(52) U.S. Cl. CPC G06T 7/0004; G06T 11/001; G06T 7/97; G06T 2207/30188

(57) ABSTRACT

A system for automatic plant monitoring includes a camera for capturing images of a plant, within a view area, over time; creating an image collection over time. A processing unit receives the images from the camera and provides a collection of samplers, each sampler representing a location within the view area. Detecting the members of said plant. The processing unit applying sampling rules for detecting the members of said plant. Taking one image from said image collection and scoring the image as a function of the image application of the rules of the image and producing a progress score

### CROSS-REFERENCE TO RELATED APPLICATIONS

This application claims the benefit of U.S. Provisional Application No. 63/069,030 filed on Aug. 22, 2020, the entire disclosure of which is hereby incorporated in its entirety.

### FIELD OF THE INVENTION

The disclosure relates generally to the field of horticulture monitoring, and more specifically to autonomous systems and for image-based monitoring of agricultural growth on individualized and grouped plant(s)/tree(s).

### BACKGROUND OF THE INVENTION

With the increasing demand for food and the aging population, more and more management software and automated cultivation systems are being used to control the agriculture activities. To function responsively, the automated systems and software need effective monitors that can provide real-time feedback on plant growth and health status.

In patent publication JP4009441B2, a crop cultivation evaluation system is used to simulate and observe the growth of plants. Among other characteristics, the heights of the plants can indicate growth progresses. But the reference doesn't offer a method to assess the length or shape.

In patent publication U.S. Pat. No. 9,582,873B2, a method is provided to use the normalized difference vegetation index (NDVI) derived from aerial image wavelength data to monitor farmland vegetation coverage. But the monitoring method described in the publication is not responsive enough for real-time automated control, because the aerial NDVI changes usually are the results of changes in growth cycles. Also, aerial image capturing is not practical in monitoring a single plant or small batches of plants in close range.

With the similar drawbacks, patent publication U.S. Pat. No. 10,192,185B2 describes a system and a method managing farmlands, in which it uses two cameras mounted on an airborne object to capture the intensity of sunlight and the intensity of the light reflected by the crops in farmlands respectively and calculates a growth index based on the captured light intensities. It is not practical in monitoring a single plant or small batches of plants in close range.

Patent publication U.S. Pat. No. 10,349,584B2 describes a well-known model and method of a supervised machine learning practice, of being used for agriculture purposes. This type of usage was also previously covered by Robert J. McQueen in his publication “Applying Machine Learning to Agricultural Data” in 1995. In this method, image data is among the types of data to be processed as inputs and fed into the machine learning systems for training, testing and making predictions. Though a powerful model, machine learning requires considerable computing power and hardware for training and executing, thus limiting its usage from broad deployment and being cost-effective in certain cases. In addition, training a supervised machine learning model requires a large set of training inputs being properly labeled by humans in many cases. Though there are cloud image repositories available for generic computer vision training purposes, the plant specific feature identification requires more in-depth imaging, growth classification and health status labeling.

The innovation disclosed here would be advantageous to provide an image-based growth monitoring solution that would overcome the deficiencies of the prior art.

### BRIEF SUMMARY OF THE INVENTION

The disclosed embodiments include: a method and system using a collection of samplers to extract location and occupancy information of plant parts in respect to a contained view area; and use the location and occupancy information of a plant relative to a juxtaposed grid, as well as the changes thereof in a time sequence, with references to plants biological behavior and interaction appearance with environments, to determine and project plant growth progress and health status.

### BRIEF DESCRIPTION OF THE SEVERAL VIEWS OF THE DRAWINGS

The present disclosure will be better understood by reading the written description with reference to the accompanying drawing figures in which like reference numerals denote similar structure and refer to like elements throughout in which:

FIG. 1 shows the structure of a collection of samplers in forms of grid cells; FIG. 2A, FIG. 2B and FIG. 2C illustrate the transformation of data in a process of extracting location and occupancy information of plant parts in respect to the containing image by a collection of samplers in forms of grid cells;

FIG. 3 shows the sampling results over time in the context of plant growth cycles and when a plant is experiencing dehydration;

FIG. 4 is a flowchart for monitoring growth as a function of an image of a plant in accordance with the invention; and

FIG. 5 shows an image-based plant growth monitoring system constructed in accordance with an embodiment of the invention.

### DETAILED DESCRIPTION OF THE INVENTION

One embodiment of the invention is illustrated as follows:

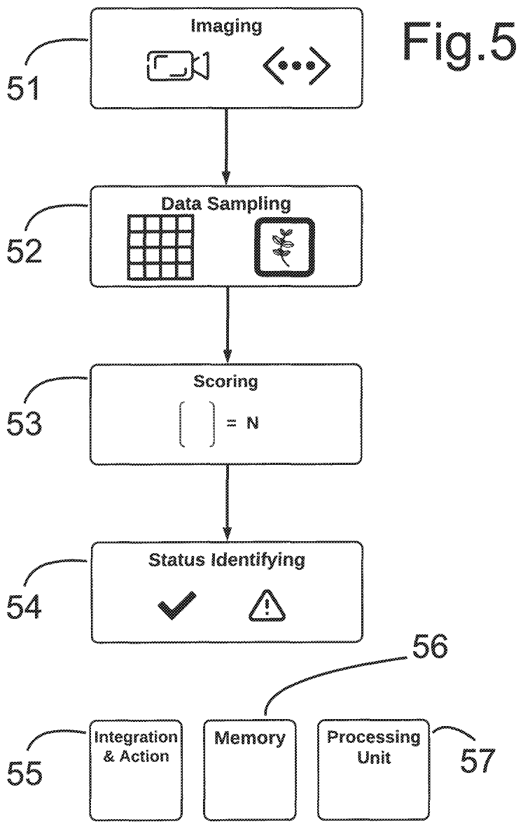

An image-based plant growth monitoring system shown in (FIG. 5) comprises Imaging Module 51, Data Sampling Module 52, Scoring Module 53, Status Identifying Module 54, and Integration & Action Module 55. The system also includes Memory 56, and Processing Unit 57, each operatively coupled to each other and each of Imaging Module 51, Data Sampling Module 52, Scoring Module 53, Status Identifying Module 54, and Integration & Action Module 55, wherein the Memory 56 contains instructions that, when executed by the Processing Unit 57, configure the system to operate monitoring and related functions as discussed below.

The system uses Imaging Module 51 (FIG. 5) to procure a time-sequenced image collection of a plant or a group of plants, then communicating with Data Sampling Module 52 (FIG. 5) processes pixels of the image to generate sampled data to reduce the number of image data to be processed as discussed below. Scoring Module 53 (FIG. 5) receives the sampled data and generates at least one progress value for the image as a function thereof. Status Identifying Module 54 (FIG. 5) receives the progress value and classifies the monitored plants' growth status based on a preset standard and to identify abnormal status such as sudden dehydration when the progress value does not meet the at least the present standard.

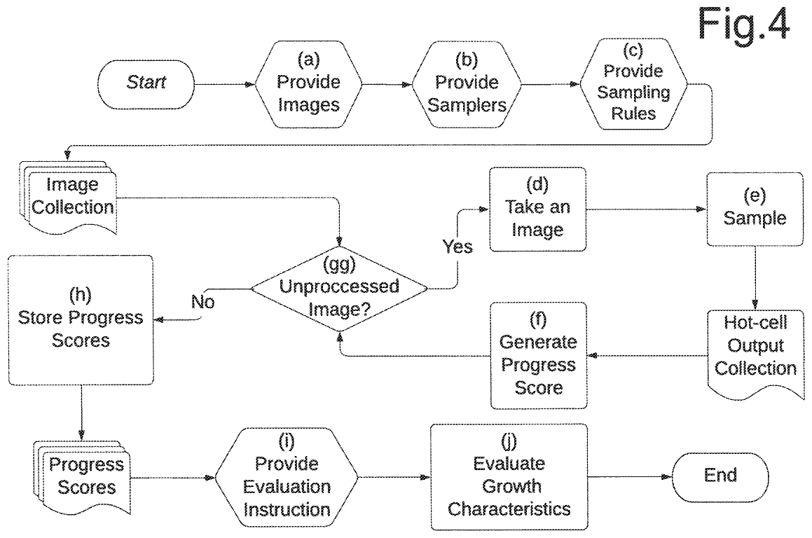

The process of the method that this system uses is more fully described in connection with FIG. 4. In a first step (a) imaging module 51 provides images of one or more monitored plants. (FIG. 4). Imaging Module 51 (FIG. 5) uses an optical camera to take a color image 4 (FIG. 2A) of a target monitored plant. A resulting view area, captured by the optical camera, contains a plant grown in a normal vertical position in the shown example. Step (a) is repeated to generate a time-sequenced image collection. The Imaging Module 51 (FIG. 5) may also obtain a time-sequenced image collection of this plants or exemplars of the species of plant, from other means, such as file transfer from network or from external storages.

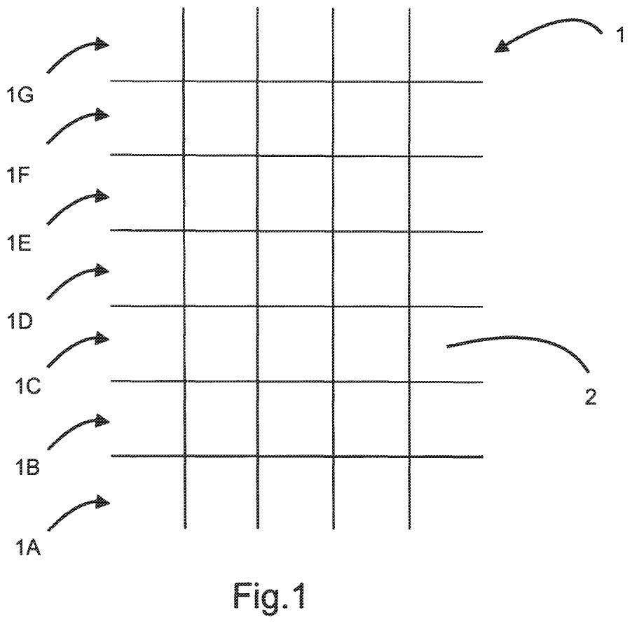

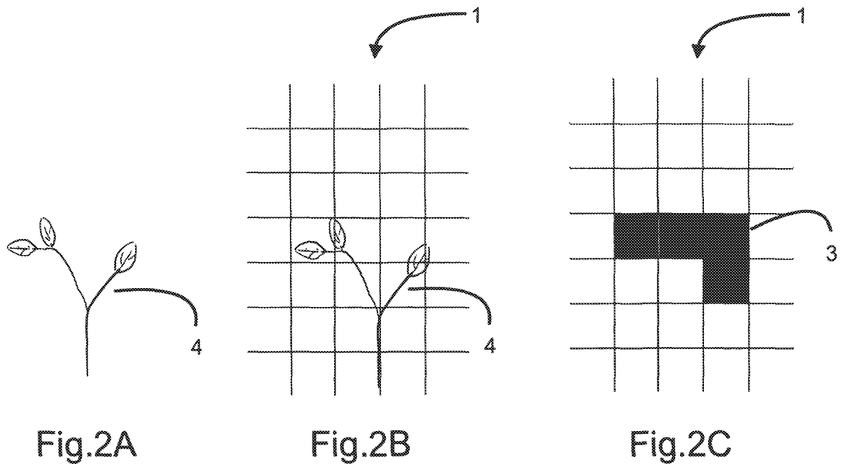

The samplers are provided in a step (b) (FIG. 4). Within Data Sampling Module 52 (FIG. 5), a grid-shaped virtual sampler collection 1 (FIG. 1) formed as multiple rows 1A-1G (FIG. 1) of cell-shaped optical samplers 2 (FIG. 1). In this embodiment, each said row 1A-1G is assigned a weighted numeric factor, as a function of its location in the gradient pattern based on the sampler's vertical position to reflect plant growth, wherein cells are of the same size. The cell factors are listed as follows.

Row/Cell Factor Table

| Row | Weighted Cell Factors |
|---|---|
| 1G | 70 |
| 1F | 60 |
| 1E | 50 |
| 1D | 40 |
| 1C | 30 |
| 1B | 20 |
| 1A | 10 |

Thus, the cell samplers 2 (FIG. 1) associated with sampling cells associated with upper parts of the view area are assigned with high values, while the cell samplers 2 (FIG. 1) associated with sampling lower parts of the view area are assigned with lower values.

The sampler collection 1, the image 4 applied to cell sampler 1, (FIG. 2B) is used to extract image pixels from an image 4 (FIG. 2A) as follows: overlap sampler collection 1 (FIG. 2B) over said image 4 (FIG. 2A) with the same vertical direction, and adjust size ratio of sampler collection 1 (FIG. 2B) so that the outer boundary of said sampler collection 1 (FIG. 2B) contains the view area to be monitored. As a result, the pixels of said image will be grouped and mapped to the cell-shaped sampler that they are contained in.

Then, in step (c) (FIG. 4) sampling rules are provided. Step (c) is performed at least in part by Data Sampling Module 52 (FIG. 5), which provides sampling rules for said samplers to detect members of the plants and generate an output collection. In one non limiting embodiment, the rules may include:
Checks if the color of leaves can be detected by analyzing the HSL/HSV values of the image pixels that fall in the scope of each of said cell-shaped sampler 2 (FIG. 1). If the pixel's Hue Angle of HSL/HSV value is between 75° and 150° (green), then the pixel is identified as a detected pixel.
If the number of detected pixels is higher than 5% of the total number of pixels in the cell, the status of the sampler is considered to be a hot cell 3 (FIG. 2C) represented in a shaded style. This step binarily identifies each sampler cell as either a hot or non-hot cell.
Each of the hot cells reports an output of the factor value associated with said cell, while each of non-hot cells will be ignored.

Then in a step (d) (FIG. 4), an image is taken from of said image collection created above.

Then in a Sample step (e) the above samplers are used by Processing Unit 57 to map image pixels and use the sampling rules established in step (c), and stored in memory 56 to generate an output collection representing hot cells with values associated with respective cells.

In a step (f), (FIG. 4). Scoring Module 53 aggregates the values in the output collection to generate a progress score. Specifically, the progress score is calculated by adding up the cell factor values of hot samplers. The formula is described as follows

Progress Score=Σ(number of a particularly valued hot cell detected)×(Factor of hot cell)

By way of non limiting example, in FIG. 2C, there are four hot cells corresponding to the number of cells overlapping the image of the observed plant. With reference to cell/row location in FIG. 1 and above Row/Cell Factor Table, there are 3 hot sampler cells with cell factor of 40, and 1 hot sampler cell with cell factor of 30. The progress score is (3×40)+(1×30)=150.

This process is repeated periodically to monitor change over time. Although the process may be repeated each period, or a predetermined multiple periods. So if photos are taken twice daily, the process could be performed twice that day, or once each twenty four hour period to process two images at a single operation.

In step (gg) it is determined whether there are any unprocessed images. If so the process is repeated at step (d) for all the images in said time-sequenced image collection. In the process of FIG. 4, this iteration is controlled by the (gg) condition; whether there is an unprocessed image in the said image collection (FIG. 4). Repeat the three steps: (d) Take an Image (FIG. 4), (e) Sample (FIG. 4), and (f) Generate Progress Score (FIG. 4) for each image in the said image collection.

After that, perform step (h) Store Progress Scores (FIG. 4) to store progress scores for evaluation in Memory 56.

Then in step (i) Status Identifying Module 54 (FIG. 5), provides an evaluating instruction to use progress scores to identify growth characteristics, represented as plants' growth progress and status in this embodiment.

This method in this embodiment provides growth references based on consensus or arbitrary estimates for a particular plant cultivar's phenotype under environmental influences. Growth reference tables, such as those shown below, by way of non limiting example, map the generated Progress Scores to growth and health status at the stage of the growth cycle of the plant. Each of the progress scores provides a snapshot of the plant growth status.

Stage 1 Growth Reference

| Score | Growth Status |
|---|---|
| >200 | Fast Growth |
| 100-200 | Normal |
| <100 | Slow Growth |

In the above example, the score of 150 will generate an evaluation result of “Normal” in terms of growth status at stage 1.

In addition, the Progress Scores are being tracked in time sequence to detect the growing status change or abnormality, with the following additional evaluation instructions:
an elevated growth status change indicates “at accelerated rate”
an sudden drop of score indicates “possible abnormal health conditions”

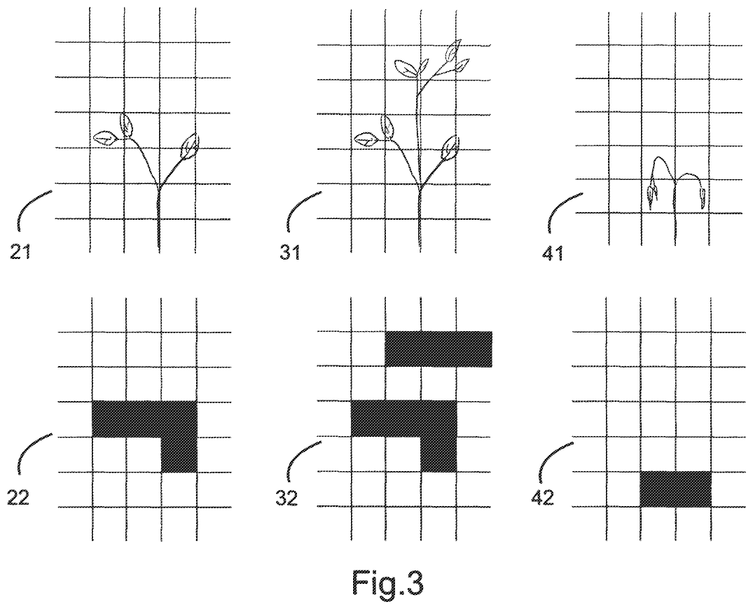

The evaluation of changes is demonstrated in the following two scenarios.
Scenario 1: The method applies to input image 31 (FIG. 3) of the same plant of stage 2, generates sample output 32 (FIG. 3), and produces a progress score of (3×60)+(3×40)+(1×30)=330 with reference to cell/row location in FIG. 1 and above Row/Cell Factor Table.

The evaluation result is “Fast Grow” according to the stage 2 growth reference table. The change of the growth status indicates that the plant is in an unusually accelerated growth path between stage 1 and stage 2. With the change evaluation instruction, the evaluation result is “fast growth at an accelerated rate”.
Scenario 2: The method applies to input image 41 (FIG. 3) which is captured soon after 21 (FIG. 3), generates a sample output 42 (FIG. 3), and produces a score of (2×20)=40 with reference to cell/row location in FIG. 1 and above Row/Cell Factor Table. A scenario when a score is reduced to 40 soon after the previous score of 150 usually indicates abrupt abnormal conditions, such as dehydration. With the change evaluation instruction, the evaluation result is “slow growth or possible abnormal health conditions.”

Stage 2 Growth Reference

| Score | Growth Status |
|---|---|
| >300 | Fast Growth |
| 200-300 | Normal |
| <200 | Slow Growth |

With the above provided evaluation instructions, the stored progress scores are used in step (i) to assess and evaluate plants' growth status to generate an evaluation result, and thus complete a process of analyzing plant image data and projecting plant growth and health status. It should be known that the results can be used to trigger remedial action, either manually, or autonomously by triggering the irrigation system to apply water, or the lighting system (for indoor facilities) to apply more light, or even monitor temperature of the environment.

To better track the progress and increase score data accuracy, mathematical models such as noise filters may be added to evaluate the progress score and its changes over time. This method uses Moving Average Filtering, one of the common noise handling models to smooth the progress scores to reduce false detections.

Integration & Action Module 55 (FIG. 5) further comprises means for notifying growth characteristics prediction results. The method provides means for notifying growth characteristics prediction results is provided to send out email, push-notifications in apps, SMS when the abnormalities such as dehydration are detected.

Integration & Action Module 55 (FIG. 5) further comprises means for accessing growth characteristics prediction results. The method provides means for accessing growth characteristics prediction results is provided in a form of web API with HTTP protocol is provided for accessing the data.

Accordingly, several advantages of one or more aspects are as follows:
a) Capable of monitoring single plant or small batches of plants in close range. The method and system can be used for small farm setups, such as indoor farms, traditional household gardens, and greenhouses;
b) Simple algorithm and readily available data inputs. This allows the method and system to be used to provide real-time actionable feedback for automated systems and management software;
c) Less demanding on computing power; and
d) Requiring no large pre-labeled training sets.

While specific embodiments have been described in detail in the foregoing detailed description and illustrated in the accompanying drawings, those with ordinary skill in the art will appreciate that various modifications and alternatives to those details could be developed in light of the overall teaching of the disclosure. For example the invention easily encompasses semi tractors and semi-trailers, which are generically also tractors and trailers. Accordingly, the particular arrangements disclosed are meant to be illustrative only and not limiting as to the scope of the invention, which is to be given the full breadth of the appended claims in any and all equivalents thereof.

1. A method of visual monitoring plant growth condition with comprising:
(a) providing a time-sequenced image collection comprising at least one image for a view area where at least one plant grow,
(b) providing a collection of samplers, wherein each of said samplers represents a location with reference to said view area,
(c) providing sampling rules for detecting the members of said at least one plant,
(d) taking one image from said image collection,
(e) producing an output collection by using sampling rules and said collection of samplers to probe said image,
(f) producing a progress score by aggregating said output collection,
(g) repeating (d) to (f) for all the images in said time-sequenced image collection,
(h) storing said progress scores in a sequence corresponding to the sequence of their respective images in said time-sequenced image collection.

2. The method of claim 1, further comprising:
(a) providing an evaluating instruction which takes inputs, wherein said inputs include said progress scores, to predict the growth characteristics of said at least one plant;
(b) executing said evaluating instruction with said progress scores to predict the growth characteristics of said at least one plant.

3. The method of claim 1, wherein said sampling rules include comparing the color information of image pixels in close proximity of the location of a sampler to a predetermined color range to determine the plant occupancy in said location of said sampler.

4. The method of claim 1, further comprising the step of applying mathematical models for enhancing score data accuracy.

5. The method of claim 1, further comprising the step of providing means for notifying growth characteristics prediction results.

6. The method of claim 1, further comprising the step of providing means for accessing growth characteristics prediction results.

7. A system for automatic plant monitoring, comprising:
a processing unit; and
a memory, the memory containing instructions that, when executed by the processing unit, configure the system to perform:
(a) providing a time-sequenced image collection comprising at least one image for a view area where at least one plant grows,
(b) providing a collection of samplers, wherein each of said samplers represents a location with reference to said view area,
(c) providing sampling rules for detecting the members of said at least one plant,
(d) taking one image from said image collection,
(e) producing an output collection by using sampling rules and said collection of samplers to probe said image,
(f) producing a progress score by aggregating said output collection,
(g) repeating (d) to (f) for all the images in said time-sequenced image collection,
(h) storing said progress scores in a sequence corresponding to the sequence of their respective images in said time-sequenced image collection.

8. The system of claim 7, wherein the system is further configured to perform:
(a) providing an evaluating instruction which takes inputs, wherein said inputs include said progress scores, to predict the growth characteristics of said at least one plant;
(b) executing said evaluating instruction with said progress scores to predict the growth characteristics of said at least one plant.

9. The system of claim 7, wherein said sampling rules include comparing the color information of image pixels in close proximity of the location of a sampler to a predetermined color range to determine the plant occupancy in said location of said sampler.

10. The system of claim 7, further comprising means for notifying growth characteristics prediction results.

11. The system of claim 7, further comprising means for accessing growth characteristics prediction results.
